(19) United States
(12) Patent Application Publication
(10) Pub. No.: US 2026/0171441 A1
(43) Pub. Date: Jun. 18, 2026

(54) METHOD FOR OPERATING A FUEL CELL SYSTEM, AND A CONTROL DEVICE

(71) Applicant: Robert Bosch GmbH, Stuttgart (DE)

(72) Inventors: Timo Bosch, Renningen (DE); Tobias Falkenau, Esslingen (DE)

(21) Appl. No.: 19/108,476

(22) PCT Filed: Sep. 11, 2023
(86) PCT No.: PCT/EP2023/074873

§ 371 Date: Mar. 4, 2025

(30) Foreign Application Priority Data
Sep. 12, 2022 (DE) 10 2022 209 498.0

(51) Int. Cl. H01M 8/04119; H01M 8/0438; H01M 8/04537; H01M 8/04664

(52) U.S. Cl. CPC H01M 8/04179; H01M 8/04388; H01M 8/04597; H01M 8/04686

(57) ABSTRACT

The invention relates to a method for operating a fuel cell system, wherein hydrogen from a tank (21) and recirculated hydrogen from a recirculation circuit (50) are supplied to at least one fuel cell (101) via a fuel line (20) as anode gas, and in which the anode gas is removed from the recirculation circuit (50) by intermittently opening a purge valve (41),
characterized in that the following steps are carried out:
opening or closing the purge valve (41)
sensing the pressure in the fuel line (20) upstream of a hydrogen metering valve (51),
checking whether a sensed pressure profile matches the opening and/or closing of the purge valve (41).

The invention further relates to a control device (27) for carrying out the method or individual method steps.

### BACKGROUND

The invention relates to a method for operating a fuel cell system. Furthermore, the invention relates to a control device configured so as to carry out the steps of the method.

A PEM fuel cell comprises a polymer electrolyte membrane arranged between an anode and a cathode. Using the PEM fuel cell, hydrogen fed to the anode and oxygen fed in the form of air to the cathode can be converted into electrical energy, heat, and water. In practical application, a plurality of fuel cells are gathered together to form a fuel cell stack, also known as a “stack,” in order to increase the generated electric voltage.

Through diffusion processes via the fuel cell, nitrogen enters the recirculation circuit on the side of the anode. A further source of nitrogen is the fresh fuel, which is not 100% pure H2. Nitrogen represents an inert gas for the fuel cell, reducing the cell voltage and thus the stack voltage, which in turn results in a loss of efficiency. Therefore, anode gas is discharged repeatedly from the recirculation circuit during a travel cycle in order to reduce the nitrogen content. This discharge is carried out with the so-called purge valve.

According to the prior art, fresh hydrogen is supplied by means of hydrogen metering valves, which can be designed as proportional valves. The control strategy provides that this valve be used to regulate the gas pressure within an anode path, measured by a pressure sensor at a defined position, to a defined target pressure depending on the system operating point. It may be necessary to feed additional fresh hydrogen due to a) consumption of H2 by the electrochemical conversion b) other losses of gas molecules from the anode space due to opening the drain valve for a long period of time when gas is discharged after complete water drainage and by opening of the purge valve.

The present invention is therefore concerned with the task of specifying a method for operating a fuel cell system that provides reliable and at the same time cost-efficient monitoring of the opening and closing of the purge valve and diagnosis of the purge valve. At the same time, the functionality of the pressure sensor in the fuel line may be checked.

In order to solve this problem, the method according to the disclosure is proposed. Advantageous embodiments of the invention can be gathered from the dependent claims. In addition, a control device for carrying out the method or individual method steps is specified.

### SUMMARY

In the proposed method for operating a fuel cell system, hydrogen from a tank and recirculated hydrogen from a recirculation circuit ais fed to at least one fuel cell as anode gas via a fuel line. As nitrogen, water, and to a minor extent other gases accumulate in the anode gas of the recirculation circuit over time, the
anode gas is removed from the system by temporarily opening a purge valve.

The following steps are carried out:
opening or closing the purge valve,
sensing the pressure in the fuel line upstream of a hydrogen metering valve,
checking whether a sensed pressure profile or pressure change matches the opening or closing of the purge valve.

When the purge valve is opened, anode gas escapes from the recirculation circuit upon opening the purge valve. The target pressure in the recirculation circuit changes and falls below the target pressure. To maintain the target pressure, hydrogen must flow downstream into the recirculation circuit via the hydrogen metering valve. To meet the increased demand for hydrogen, the opened hydrogen metering valve is opened even further. This occurs abruptly and can be sensed as a pressure change in the fuel line upstream of the hydrogen metering valve.

It is advantageous if the signal from a pressure sensor in the fuel line is evaluated to detect the sudden change in pressure in the fuel line, as this is a simple and accurate way of detecting a change in pressure.

If an error message occurs via a defective purge valve, it is advantageous if there is no drop or increase in the pressure profile, in particular an expected pressure profile, after opening or closing the purge valve, because this allows a user to quickly initiate countermeasures in order to avoid damage to the fuel cell stack caused by the defective purge valve.

There is a further advantage if the actuator current for controlling the hydrogen metering valve is evaluated to detect the sudden change in pressure in the fuel line, as no additional costs are incurred by the pressure sensor.

Furthermore, it is proposed that signals that are used as the basis for the evaluation of the actuator current are previously subjected to a filtering and/or averaged over time. In this way, the accuracy of the evaluation can be increased.

A debounce time of the purge valve may be considered when evaluating the pressure. This means that a certain time offset between the activation and opening of the purge valve is included in the evaluation. In this way, the accuracy of the evaluation can be further increased.

It is advantageous if an error message is output via a defective pressure sensor, if the opening or closing of the purge valve is completed and if there is no drop or increase in the pressure profile, in particular an expected pressure profile, because in this way countermeasures can be taken quickly to avoid damage to the components of the fuel cell system due to an incorrect pressure measurement.

In a fuel cell system with at least two fuel cell stacks having at least two fuel cells each with a fuel line, a recirculation circuit and a purge valve, respectively, it is advantageous to operate the purge valves decoupled from each other so that only one purge valve can be opened at a time. In this way, an error message or failure of a purge valve or pressure sensor can be unambiguously assigned to a component.

In addition, a control device that is configured so as to carry out steps of the method according to the invention is proposed. In particular, the actuator current required to actuate the hydrogen metering valve can be acquired and evaluated using the control device. To evaluate the actuator current, a corresponding algorithm is preferably stored in the control device.

If each fuel cell stack in the fuel cell system has a separate control device, the purge and/or drain function of the plurality of stacks may be performed sequentially and preferably not in parallel through communication between the fuel cell stacks.

### BRIEF DESCRIPTION OF THE DRAWINGS

The invention and its advantages are explained in more detail below with reference to the accompanying drawings.

FIG. 1 shows a schematic illustration of a topology of a fuel cell system according to a first exemplary embodiment, and

FIG. 2 shows a schematic illustration of a topology of a fuel cell system according to a second exemplary embodiment.

### DETAILED DESCRIPTION

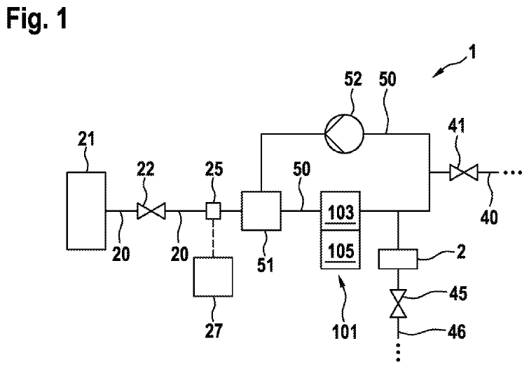

FIG. 1 shows a schematic topology of a fuel cell system 1 according to a first exemplary embodiment of the invention, having at least one fuel cell stack 101.

The fuel cell stack 101 has a cathode side 105 and an anode side 103. The anode side 103 is supplied with hydrogen via a fuel line 20. The fuel line 20 is located between a pressure control valve 22 and a hydrogen metering valve 51.

Upstream of the pressure control valve 22 is a high-pressure tank 21 which is connected to the pressure control valve 22 via a further line. Additional components can be arranged in the further line and in the fuel line 20 so as to supply fuel to an anode side 103 of the fuel cell stack 101 as needed. With the help of the pressure control valve 22, enough hydrogen is added to the fuel line 20 so that the pressure in the fuel line 20 is maintained at the most constant value possible.

Excess fuel, as well as certain amounts of water and nitrogen that diffuse through the cell membranes onto the anode side 103, are returned to a recirculation circuit 50 and mixed with the metered fuel from the fuel line 20.

Various components, such as a fan 52, can be installed to drive the flow in the recirculation circuit 50. The hydrogen metering valve 51 is arranged at the transition between the fuel line 20 and the recirculation circuit 50.

The hydrogen metering valve 51 ensures the supply of fresh hydrogen to the recirculation circuit 50. The hydrogen metering valve 51 can be designed as a proportional valve. The control strategy in the fuel cell system envisages using the hydrogen metering valve 51 to regulate the gas pressure within the recirculation circuit 50 to a defined target pressure depending on the system operating point. Reasons for the replenishment of fresh hydrogen can be the consumption of hydrogen by the electrochemical conversion within the fuel cell stack 101 or other losses of gas molecules from the recirculation circuit 50, such as due to opening of the drain valve 45 or the purge valve 41.

In the event of a change in the operating point, larger or smaller amounts of hydrogen are temporarily conveyed from the fuel line 20 to the recirculation circuit 50 by the hydrogen metering valve. As the pressure control valve 22 is sluggish, brief fluctuations may occur in the pressure in the fuel line 20.

A water separator 2 is integrated in the recirculation circuit 50 to separate water from the anode gas in the recirculation circuit 50. The water separator 2 has a container for collecting the separated water. In order to empty this container, the water separator 2 is connected to a drain valve 45 via a drain line 46. The drain line 46 typically discharges the excess water into an exhaust line, which is connected to the surrounding environment.

A pressure sensor 25 is arranged in the fuel line 20. The pressure sensor 25 is arranged upstream of the hydrogen metering valve 51 and measures the pressure between the pressure regulator 22 and the hydrogen metering valve 51 in the fuel line 20.

The method according to the invention provides that, while the purge valve 41 is opened or closed, the pressure in the fuel line 20 is simultaneously sensed upstream of the hydrogen metering valve 51. A check is completed to determine whether the sensed pressure profile matches the opening or closing of the purge valve 41. When the purge valve 41 is opened, the pressure in the fuel line 20 should drop as the hydrogen metering valve 51 will temporarily convey more hydrogen into the recirculation circuit 50. When the purge valve 41 closes, the pressure in the fuel line 20 should increase for a short time, as the hydrogen metering valve 51 needs to add less hydrogen.

When monitoring the pressure in the fuel line 20 during opening or closing of the purge valve 41, a comparison can also be completed with a saved pressure profile.

An error message occurs via a defective purge valve 41 if there is no drop or increase in the pressure profile in the fuel line 20, in particular an expected pressure profile, after opening or closing the purge valve 41.

To sense the pressure in the fuel line 20, the signal from the pressure sensor 25 in the fuel line 20 can be evaluated according to a first exemplary embodiment.

According to a second embodiment, the actuator current for actuating the hydrogen metering valve 51 can be evaluated to detect the change in pressure in the fuel line 20. If the actuator current rises above a threshold value, a large amount of fuel is fed through the hydrogen metering valve 51 into the recirculation circuit 50. The pressure in the fuel line 20 between pressure control valve 22 and hydrogen metering valve 51 consequently drops.

A control device 27 of the fuel cell system 1 can be used to evaluate the actuator current, with the aid of which the hydrogen metering valve 51 is controlled.

Preferably, no change in the operating conditions or the load should occur during the method according to the invention; if this does occur, any load change that occurs is taken into account when evaluating the actuator current or pressure.

In an alternative exemplary embodiment, the sensed pressure profile may be compared to the opening or closing of the purge valve to check the function of the pressure sensor 25. To this end, it must be ensured in another way that the purge valve 41 has been opened or closed.

The opening or closing of the purge valve 41 may be determined, for example, via a measurement in which an increase in the hydrogen concentration in a line downstream of the purge valve 41 is sensed. This may be a measurement by a hydrogen sensor disposed in an exhaust line, wherein gases discharged by the purge valve are directed from the recirculation circuit into the exhaust line upstream of the hydrogen sensor.

An error message can be generated via the defective pressure sensor 41 if the opening or closing of the purge valve 41 has been carried out safely and no drop or increase in the pressure profile, in particular an expected pressure profile, takes place.

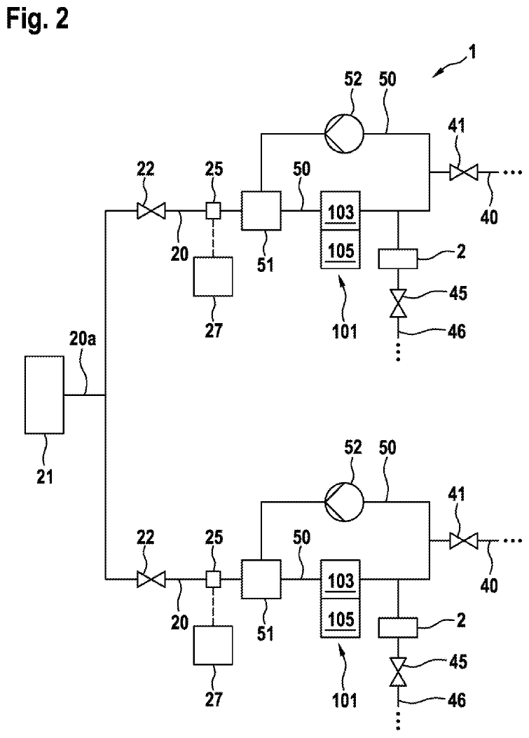

FIG. 2 shows a fuel cell system 1 according to a second exemplary embodiment with at least two fuel cell stacks 101, wherein each fuel cell stack 101 comprises a fuel line 20, a recirculation circuit 50 a purge valve 41, a hydrogen metering valve 51, a pressure control valve 22, and a pressure sensor 25, respectively, arranged in the fuel line. The further components of the fuel cell system 1 having at least two fuel cell stacks 101 likewise do not differ from the arrangement described in the first exemplary embodiment. A single hydrogen tank 21 or tank system is connected to another line 20a, which has a branch and is connected to the respective pressure control valves 22.

In order to unambiguously associate an error with a purge valve 41 or pressure sensor 25 of the respective fuel cell stack 101 during diagnostics, the purge valves 41 should operate decoupled from one other such that only one purge valve 41 can be open at a time.

1. A method for operating a fuel cell system (1), wherein hydrogen from a tank (21) and recirculated hydrogen from a recirculation circuit (50) are supplied to at least one fuel cell (101) via a fuel line (20) as anode gas, and in which the anode gas is removed from the recirculation circuit (50) by intermittently opening a purge valve (41),
wherein the following steps are carried out:
opening or closing the purge valve (41)
sensing the pressure in the fuel line (20) upstream of a hydrogen metering valve (51),
checking whether a sensed pressure profile matches the opening or closing of the purge valve (41).

2. The method according to claim 1,
wherein the signal of a pressure sensor (25) in the fuel line (20) is evaluated to sense the pressure in the fuel line (20).

3. The method according to claim 2,
wherein an error message is generated via a faulty purge valve (41) if there is no drop or increase in the pressure profile after opening or closing the purge valve (41).

4. The method according to claim 1,
wherein the actuator current for actuating the hydrogen metering valve (51) is evaluated to sense the pressure in the fuel line (20).

5. The method according to claim 4,
wherein a control device (27) of the fuel cell system (1), with the aid of which the hydrogen metering valve (51) is actuated, is used to evaluate the actuator current.

6. The method according to claim 3,
wherein an adjustment of the sensed pressure profile and the evaluated actuator current are carried out to check the function of the pressure sensor (25).

7. A method according to claim 6, wherein an error message is generated via a defective pressure sensor (25) if the opening or closing of the purge valve (41) is complete and there is no drop or increase in the pressure profile.

8. A method according to claim 1, wherein the fuel cell system comprises at least two fuel cell stacks (101) each having a fuel line (20), a recirculation line (50), and a purge valve (41),
wherein the purge valves are operated decoupled from one other such that only one purge valve may be opened at a time.

9. A control device configured to control a fuel cell system (1), wherein hydrogen from a tank (21) and recirculated hydrogen from a recirculation circuit (50) are supplied to at least one fuel cell (101) via a fuel line (20) as anode gas, and in which the anode gas is removed from the recirculation circuit (50) via a purge valve (41), by
controlling opening or closing the purge valve (41),
sensing, via a pressure sensor, the pressure in the fuel line (20) upstream of a hydrogen metering valve (51), and
checking whether a sensed pressure profile matches the opening or closing of the purge valve (41).
